(19) United States
(12) Patent Application Publication
(10) Pub. No.: US 2018/0276649 A1
(43) Pub. Date: Sep. 27, 2018

(54) System and Method for Conducting Secure Credit, Debit, and Retail Card Transactions

(71) Applicant: U-Lock (Pty) Ltd., Pretoria (ZA)

(72) Inventor: Tshepo Edwin Mpete, Pretoria North (ZA)

(21) Appl. No.: 15/521,454

(22) PCT Filed: Apr. 29, 2015
(86) PCT No.: PCT/ZA2015/000030

§ 371 Date: Apr. 24, 2017

(30) Foreign Application Priority Data
Nov. 12, 2014 (ZA) 2014/08303

(51) Int. Cl. G06Q 20/32; G06Q 20/34

(52) U.S. Cl. CPC G06Q 20/3223; G06Q 20/354; G06Q 20/3255; G06Q 20/3229

(57) ABSTRACT

The system includes a transaction card having a card identifier number, a telecommunications network through which a user and service provider are capable of communicating a service provider database for storing at least the card identifier number against a corresponding authentication pin number, a USSD protocol through which the user is capable of securely communicating with the service provider through a USSD gateway and a mobile telecommunications device for enabling the user communications. The mobile device comprises means for enabling the user to dial a USSD string for initiating communication between the user and the service provider through the USSD protocol via the telecommunications network; enabling the user to input the authentication pin number, wherein the service provider database is in use interrogated with the inputted authentication pin number to authenticate the user and on authentication, enabling the user to send a command to switch the card and/or a card account linked between passive, active, or stopped states.

### BACKGROUND OF THE INVENTION

THIS invention relates to a system and method for conducting secure credit, debit and retail card transactions. More specifically, the invention relates to a system and method for combating fraudulent card transactions.

Card related fraud is rife in the banking industry, with banks losing millions in revenue in investigating fraudulent cases and where necessary recouping their clients for loses. Nowadays, and with crime on a continual increase, most people are nervous to carry cash and as such, transact mainly using some or other card (i.e. credit, debit, cheque, retail, loyalty, etc.).

Credit cards for example are particularly vulnerable to fraud. Making a card transaction historically required a merchant to simply swipe the card through the point of sale (POS) machine or terminal. In the past, such machines where non-portable requiring the customer to be momentarily separated from his/her card. This momentary separation was the gap a fraudster required to record the credit card number and the card verification value (CW) on the reverse of the card—all which is required to conduct, for example, fraudulent internet transactions.

To combat this, portable POS terminals were developed and are still common place today. The portable POS terminals allows the card holder to be physically present and keep a watch of his/her card while the transaction is processed by a merchant, thereby eliminating the momentary separation of the card from the card holder.

Although portable POS terminals appeared to be the solution to combat card fraud, the advent of palm sized scanners quickly put fraudsters back in business. Fraudsters while processing a transaction quickly swipe the card through their own palm sized scanners, thereby recording all information stored on the magnetic strip thereon. From this information, the fraudsters make cloned cards and transact as normal.

The banking industry has recently introduced another layer of security in an attempt to combat card fraud, that being the introduction of a chip onto the card on which sensitive information is stored, thereby making card cloning near impossible and requiring a card holder to enter a pin number into the POS machine to verify a transaction.

However, many POS terminals currently out in the retail environment are not yet compatible with the security chip technology, forcing card issuers to issue cards with not only the chip but also the magnetic strip, which remains vulnerable to fraud.

It is clear that to properly combat card related fraud, cards must be issued as chip only cards. Having said that, the process of replacing existing POS terminals with chip compatible ones is an expensive and timely affair, forcing bank institutions to consider alternative fraud combating techniques in the meantime.

One such technique, as envisaged by the inventor of the present invention, is to maintain a card in a deactivated state and only activate the card at the time of making a transaction, i.e. a system and method of switching the card on and off as required. An obvious device on which such a system may function is a mobile smart phone, making use of a downloadable application to switch the card on and off, which is in fact already well known.

However, although mobile smart phones have significant penetration in first world markets, many card holders around the world, and particularly in third world countries, carry simply GSM telecommunications devices that do not support the aforementioned downloadable applications.

Accordingly, it is an object of the present invention to provide a system and method for switching a card on and off, between respective active and passive states, through an unstructured supplementary service data protocol (USSD) operable on any mobile telecommunications device.

### SUMMARY OF THE INVENTION

According to the invention there is provided a system for conducting secure card transactions including:
a transaction card having a card identifier number;
a telecommunications network through which a user and a service provider are capable of operatively communicating;
a service provider database for storing at least the card identifier number against a corresponding authentication pin number;
a USSD protocol through which the user is operatively capable of securely communicating with the service provider through a USSD gateway; and
a mobile telecommunications device having means for:
   operatively enabling the user to dial a USSD string for initiating communication between the user and the service provider through the USSD protocol via the telecommunications network;
   operatively enabling the user to input the authentication pin number, wherein the service provider database is in use interrogated with the inputted authentication pin number to authenticate the user; and
   on authentication of the user, operatively enabling the user to send a command to switch the card and/or a card account linked thereto between passive, active and/or stopped states thereby to prevent the processing of any transactions other than with the card and/or a card account in the active state.

The card may be any card from a group of cards including credit cards, debit cards, cheque cards, retail cards and loyalty cards.

It will be appreciated that the service provider database may be capable of storing a plurality of card identifier numbers of other user transaction cards against the corresponding authentication pin number.

Generally, the mobile communications device comprises means for launching a first user screen prompt for prompting the user to input the authentication pin number, the launching of the first user screen prompt being triggered on the operative dialing of the USSD string by the user.

Typically, the mobile communications device comprises means for launching a second user screen prompt for prompting the user to select, from a list of card identifier numbers, the card identifier number of the card the user wishes to switch the state of, the launching of the second user screen prompt being triggered on the operative authentication of the user.

Preferably, the second user screen prompt is capable of reflecting the real-time active, passive or stopped states of each of the relevant cards.

The mobile communications device may further comprise means for launching a third user screen prompt for prompting the user to select any one of at least the following commands: (i) switching the card to the active state; (ii) switching the card to the passive state; (iii) stopping the card; and/or (iv) updating the remaining transactions on a card already in the active state, the launching of the third user screen prompt being triggered on the operative selection of the relevant card identifier number by the user.

Generally, the mobile communications device comprises means for launching a fourth user screen prompt for prompting the user to select a parameter of the activation, the launching of the fourth user screen prompt being triggered on the user operatively selecting the activate or update command.

Typically, the activation parameter is a number of allowable transactions or a length of time, such that on the number of allowable transactions being reached and/or the lapse of the selected length of time, the card and/or card account is automatically switched back to the passive state.

Preferably, the mobile communications device comprises means for launching a fifth user screen prompt for notifying the user that the command has been processed, following which the USSD connection is terminated by the system, the launching of the fifth user screen prompt being triggered on the user operatively making a command selection on the third and/or fourth user screen prompts.

In a particularly preferred embodiment of the invention, the notification of the fifth user screen prompt is forwarded to the user by short message service (SMS).

In an alternative embodiment of the invention, the authentication pin number and one or more card identifier numbers may be stored on the service provider database against a corresponding user telephone number such that the user is only authenticated in use where the authentication pin number matches the telephone number of the mobile telecommunications device from which communication is initiated.

Generally, the first user screen prompt includes an option to register for the service and further wherein the mobile communications device comprises means for launching a first registration screen prompt, the launching of the first registration screen prompt being triggered on: (i) the user operatively selecting the option to register on the first user screen prompt; and (ii) following authentication of the telephone number of the mobile telecommunications device from which communications are initiated.

Typically, the first registration screen prompt in use prompts the user to enter an identifier number, in the form of a passport number or any other identifier of the user.

Preferably, the mobile communications device comprises means for launching a second registration screen prompt for prompting the user to enter the authentication pin number, the launching of the second registration screen prompt being triggered on the operative inputting of the user's identifier number by the user.

Furthermore, the mobile communications device may comprise means for launching a third registration screen prompt for notifying the user that the authentication pin number has been accepted and that the user has been registered, the launching of the third registration screen prompt being triggered on the operative authentication of the authentication pin number arising from the authentication pin number meeting certain pre-set parameters (i.e. 5 digits in length).

Generally, the second user screen prompt further includes an option for the user to upload the card identifier numbers of one or more transaction cards of the user.

According to a second aspect of the invention, there is provided a method for conducting secure card transactions including the steps of:
(A) sending a communication initiation command by a user through the dialing a USSD string on a mobile telecommunications device;
(B) communicating the communication initiation command to a service provider through a USSD protocol via a telecommunication network to setup a USSD gateway between the user and the service provider;
(C) prompting the user for an authentication pin number and sending the authorisation pin number to the service provider;
(D) interrogating a service provider database with the authentication pin number for authenticating the user;
(E) prompting an authenticated user for:
   (i) a command to switch a transaction card and/or account linked thereto between passive, active and/or stopped states thereby to prevent the processing of any transactions other than with the card and/or card account in the active state; or
   (ii) a command to update the state of an already active card and/or card account;
(F) switching the card and/or card account linked thereto to the state selected by the user, or updating the state of the already active card and/or card account; and
(G) automatically switching the card and/or card account to the passive state on attainment of a pre-set activation parameter.

The card used in the method may be any card from a group of cards including credit cards, debit cards, cheque cards, retail cards and loyalty cards.

Generally, the service provider database is capable of storing a plurality of card identifier numbers of other user transaction cards against the corresponding authentication pin number.

Typically, the step of prompting the user for the command to switch or update the states of the card and/or card account is preceded by the step of prompting the user for a card identifier number selection from a list of card identifier numbers associated with the authentication pin number, such that the switching or updating command is applied to the card associated with the card identifier number selected by the user.

Preferably, the method includes a step of prompting the user for the activation parameter following the user sending the update command. It will be appreciated that activation parameter may be a number of allowable transactions or a length of time, such that on the number of allowable transactions being reached and/or the lapse of the selected length of time, the card and/or card account is automatically switched back to the passive state.

The method further includes the step of sending a notification to the user confirming that the relevant command has been process. Generally, the notification is sent through the USSD gateway and/or through short message service (SMS).

In an alternative embodiment of the invention, the authentication pin number and one or more card identifier numbers may be stored on the service provider database against a corresponding user telephone number such that the interrogating and authenticating step of the method is only concluded where the authentication pin number matches the telephone number of the mobile telecommunications device from which communication is initiated.

In a particularly preferred embodiment of the invention, the method commences with registration of the user through the steps of:
(A) sending a communication initiation command by a user through the dialing a USSD string on a mobile telecommunications device;
(B) communicating the communication initiation command to a service provider through a USSD protocol via a telecommunication network to setup a USSD gateway between the user and the service provider;
(C) prompting the user for a registration command;
(D) authenticating the user through one or more authentication procedures;
(E) prompting the user for an authentication pin number; and
(F) on receipt of the authentication pin number, notifying the user of successful registration.

Generally, the authentication procedures include authentication of a telephone number of the mobile communications device from which communication was initiated, and/or authentication of a user identifier number, typically being a passport number or some other identifier of the user.

Preferably, the user will only be successfully registered where the authentication pin number meets certain pre-set parameters (i.e. 5 digits in length).

Once registered, the method may include a further step of prompting the user to upload the card identifier numbers of one or more transaction cards of the user.

### BRIEF DESCRIPTION OF THE DRAWINGS

The invention will now be described in more detail, by way of example only, with reference to the accompanying drawings in which:

FIG. 1 is a schematic representation of the system employed in the present invention;

FIG. 2 is a flow diagram of the registration methodology employed in the present invention;

FIG. 3 is a flow diagram of the user methodology employed in the present invention; and

FIG. 4A-H are exemplary screen prompts employed in the USSD user interface of the present invention.

### DETAILED DESCRIPTION OF THE DRAWINGS

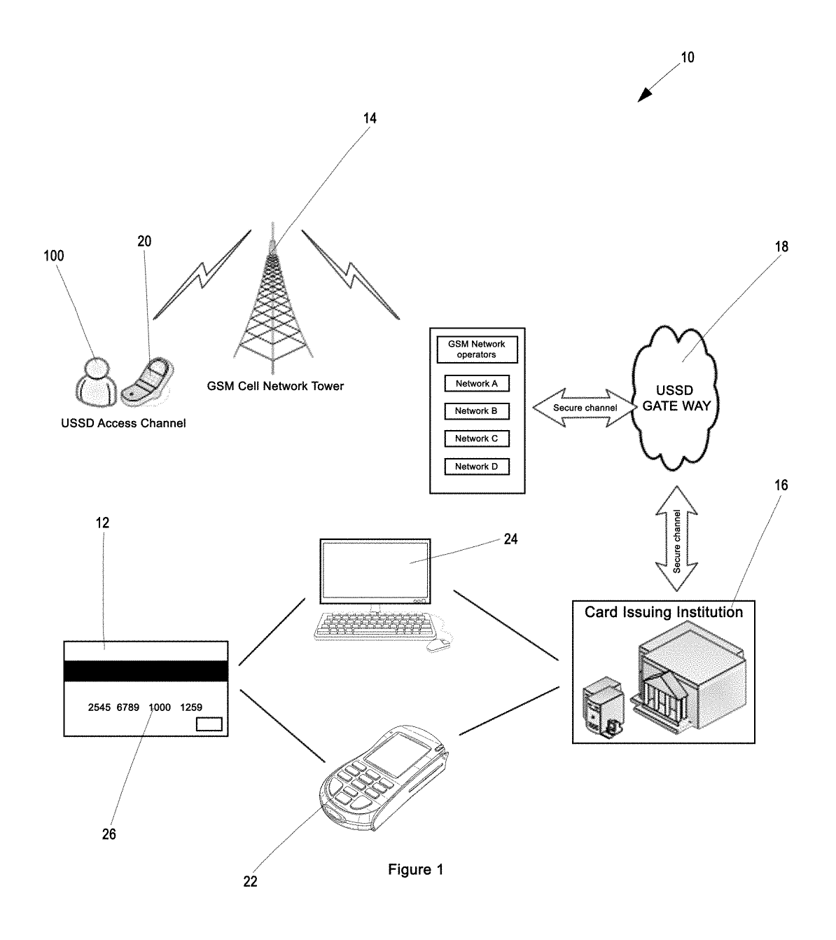

A system and method for conducting secure credit, debit and retail card transactions according to a preferred embodiment of the invention is represented schematically in FIG. 1, designated generally with reference numeral 10.

The system 10 includes a transaction card 12, a telecommunications network 14, a service provider database 16 preferably maintained by a service provider, a USSD protocol 18 and a mobile telecommunications device 20 typically belonging to a user 100 of the system 10.

The card 12 may be a debit, cheque, retail or loyalty card, but is preferably a credit card 12, through which payment to a merchant may be made by the user 100 via a point of sale terminal (POS) 22 or through an on-line payment platform from an internet connectable device 24.

The card 12 comprises a card identifier number 26, which may be uploaded to the service provider database 16 by the user 100 through the USSD protocol 18 via the telecommunications network 14, generally being a GSM network thereby enabling users other than those having smart phone type mobile communication devices to make use of the system 100.

Typically, one or more card identifier numbers 26 of the user 100 may be stored on the service provider database 16 against a corresponding authentication pin number selected by the user 100 during a registration process.

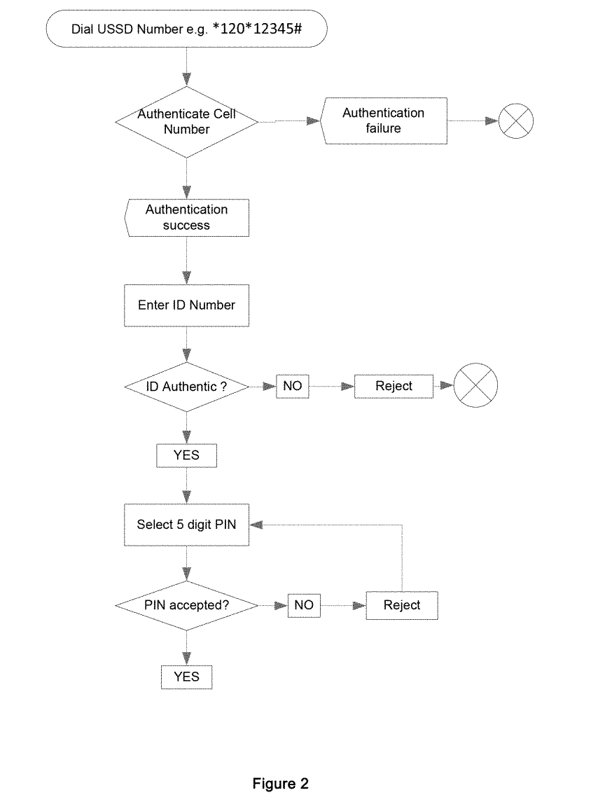

In use and with reference now also to FIG. 2 illustrating the registration methodology employed in the system 10, the user 100 dials a USSD string into their mobile communications device 20 to initiate communication with the service provider 16 through the establishment of a USSD gateway 18 between the user 100 and the service provider 16. An example of a USSD string that may be dialed by the user is in the format *120*12345#.

On receipt of the USSD string by the service provider 16, a USSD communication gateway is established between the user 100 and the service provider 16. On establishment of the USSD gateway, the telephone number of the user's mobile telecommunication device 20 enters an authentication procedure.

If the telephone number cannot be authenticated, the USSD gateway is terminated. If the telephone number is authenticated, the user 100 is prompted to input an identifier number, typically in the form of an identification number or passport number.

Once inputted, the user's identifier number enters an authentication procedure. If the user's identifier number cannot be authenticated, the user's registration request is rejected and the USSD gateway is terminated. If the user's identifier number is authenticated, the user 100 is prompted to input an authentication pin number which the user 100 will use to log into the USSD application.

Once inputted, the authentication pin number is compared to pre-set parameters, for example, having to be 5 or more digits. If the authentication pin number does not meet the pre-set parameters, the authentication pin number is rejected and the user is prompted to re-input another authentication pin number meeting the required pre-set parameters. If the authentication pin number meets the pre-set parameters, the authentication pin number is accepted.

On acceptance of the authentication pin number, the user 100 is successfully registered with a notification to this effect being displayed on the screen of the mobile telecommunications device 20, followed by a further short message service (SMS) notification.

Once the user 100 is registered, the card identifier numbers of the user's various cards 12 may be uploaded to the service provider database 16 to be stored against the authentication pin number selected by the user 100 during registration.

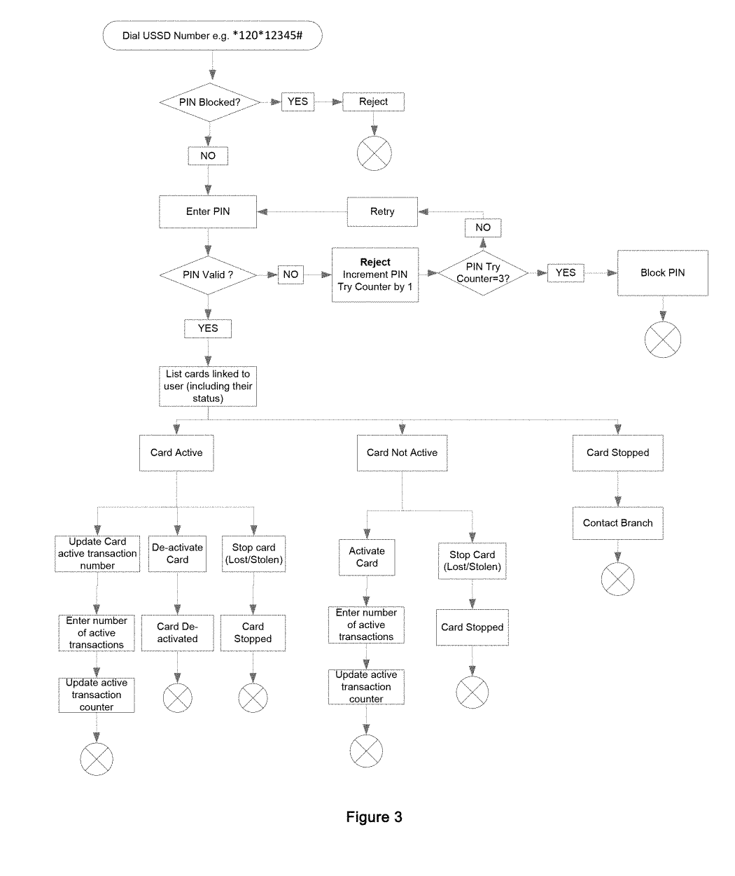

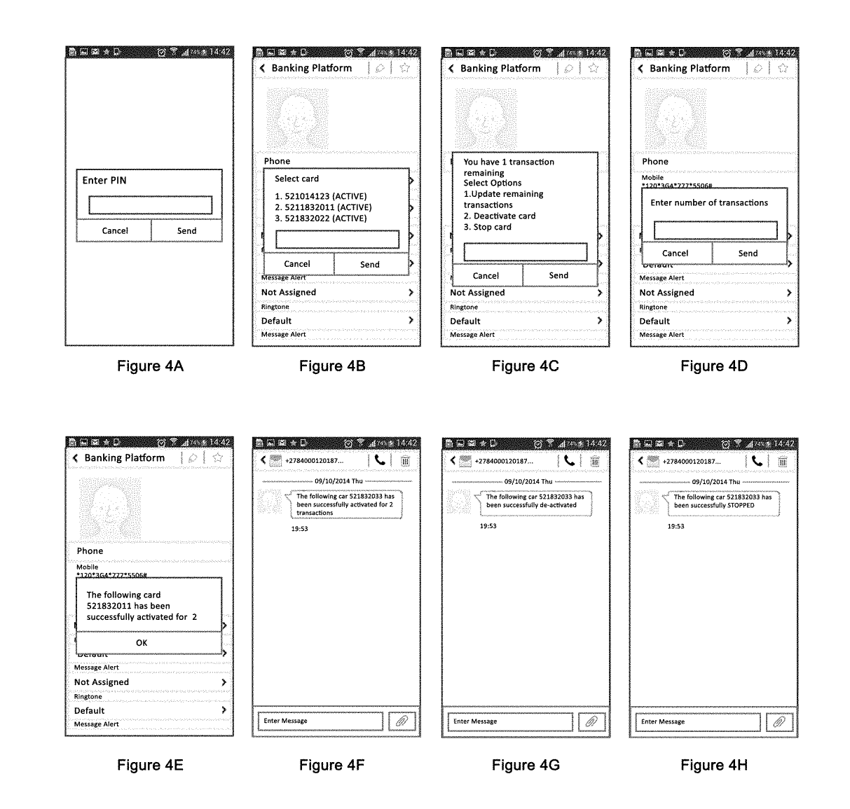

In use and with reference now also to FIG. 3 and FIG. 4 respectively illustrating the user methodology employed in the system 10 and exemplary screen prompts making up the USSD user interface, the user 100 dials a USSD string into their mobile communications device 20 to initiate communication with the service provider 16 through the establishment of a USSD gateway 18 between the user 100 and the service provider 16.

It will be appreciated that the same USSD string used during the registration procedure may be used to dial into the user interface, i.e. string *120*12345#. After establishment of the USSD gateway 18, the user 100 is prompted to enter the authentication pin number as shown in FIG. 4A.

Once inputted, the authentication pin number is authenticated for validity. If the authentication pin number is invalid, the authentication pin number is rejected and the user 100 is prompted to try another authentication pin number. The user 100 will have a predetermined number of attempts, i.e. three attempts, to log in following which the user 100 will be blocked from further attempts.

If the authentication pin number is valid and accordingly authenticated, the list of card identifier numbers stored on the service provider database 16 against the inputted authentication pin number is displayed on the screen of the mobile communications device 20 as shown in FIG. 4B. Preferably, the real-time passive, active or stopped states of each of the cards 12 and/or card accounts linked thereto are displayed.

At this point, the user 100 is prompted to select the relevant card identifier number relating to the card 12 and/or the card account linked thereto the user 100 wishes to switch states of or update.

Once selected, a list of commands are displayed on the screen of the mobile communications device 20 as shown in FIG. 4C, prompting the user 100 to: (i) switch the selected card 12 to the active state; (ii) switch the card 12 to the passive state; (iii) stop the card 12; and/or (iv) update the remaining transactions on a card 12 already in the active state.

Where the user 100 selects to activate a passive card 12, or to update the remaining transactions on an already active card 12, the user 100 is prompted to enter an activation parameter, as shown in FIG. 4D.

It will be appreciated that the activation parameter may be a number of allowable transactions or a length of time, such that on the number of allowable transactions being reached and/or the lapse of the selected length of time, the card 12 and/or card account linked thereto is automatically switched back to the passive state.

Once the user's command has been processed, a notification screen is displayed on the screen of the mobile communications device 20 as shown in FIG. 4E. The notification is preferably also communicated to the mobile communications device 20 of the user by short message service (SMS) as shown by FIGS. 4F to 4H.

Accordingly, it will be appreciated the system and method of the present invention will prevent the processing of any transactions where the card 12 and/or a card account linked thereto are in any state other than the active state. With user's transacting with their cards 12 through the USSD system and method of the present invention, card fraud may be reduced significantly.

Although the invention has been described above with reference to preferred embodiments, it will be appreciated that many modifications or variations of the invention are possible without departing from the spirit or scope of the invention.

For example, the system 10 may include the transmission of an alert SMS to the valid card holder (i.e. user 100) and/or the fraud investigation department of the service provider 16 in the event of an attempted transaction with the card 12 in a passive state.

It will be appreciated further that the system and method of the present invention, over and above its use in combating card fraud, also has the advantage of significantly reducing the costs on stopping a card. Traditionally, users were forced to deal through service provider call centres to stop a lost or stolen card, leading to expensive call costs and often a delay in having the card stopped before a fraudulent transaction is processed.

The system and method of the present invention offers a cheap and efficient self-service security advantage to its users.

1. A system for conducting secure card transactions including:
a transaction card having a card identifier number;
a telecommunications network through which a user and a service provider are capable of operatively communicating;
a service provider database for storing at least the card identifier number against a corresponding authentication pin number and a corresponding user telephone number;
a USSD protocol through which the user is operatively capable of securely communicating with the service provider through a USSD gateway; and
a mobile telecommunications device having means for:
operatively enabling the user to dial a USSD string for initiating communication between the user and the service provider through the USSD protocol via the telecommunications network;
operatively enabling the user to input the authentication pin number, wherein the service provider database is in use interrogated with the inputted authentication pin number to identify the user telephone number corresponding thereto;
authenticating the user, the user being authenticated in use when the corresponding user telephone number, stored in the service provider database against the authentication pin inputted by the user, matches the telephone number of the mobile telecommunications device from which communication is initiated; and
on authentication of the user, operatively enabling the user to send a command to switch at least one of the card and a card account linked thereto between at least one of passive, active and stopped states thereby to prevent the processing of any transactions other than with at least one of the card and a card account in the active state.

2-3. (canceled)

4. A system according to claim 1, wherein the mobile communications device comprises means for launching any one or more of:
a first user screen prompt for prompting the user to input the authentication pin number, the launching of the first user screen prompt being triggered on the operative dialing of the USSD string by the user;
a second user screen prompt for prompting the user to select, from a list of card identifier numbers, the card identifier number of the card the user wishes to switch the state of, the launching of the second user screen prompt being triggered on the operative authentication of the user;
a third user screen prompt for prompting the user to select any one of at least the following commands: (i) switching the card to the active state; (ii) switching the card to the passive state; (iii) stopping the card; and/or (iv) updating the remaining transactions on a card already in the active state, the launching of the third user screen prompt being triggered on the operative selection of the relevant card identifier number by the user;
a fourth user screen prompt for prompting the user to select a parameter of the activation, the launching of the fourth user screen prompt being triggered on the user operatively selecting the activate or update command; and
a fifth user screen prompt for notifying the user that the command has been processed, following which the USSD connection is terminated by the system, the launching of the fifth user screen prompt being triggered on the user operatively making a command selection on at least one of the third and fourth user screen prompts.

5. (canceled)

6. A system according to claim 4, wherein the second user screen prompt is capable of reflecting the real-time active, passive or stopped states of each of the relevant cards.

7-8. (canceled)

9. A system according to claim 6, wherein the activation parameter is a number of allowable transactions or a length of time, such that on at least one of the number of allowable transactions being reached and the lapse of the selected length of time, at least one of the card and card account is automatically switched back to the passive state.

10. (canceled)

11. A system according to claim 9, wherein the notification of the fifth user screen prompt is forwarded to the user by short message service (SMS).

12. (canceled)

13. A system according to claim 11, wherein the first user screen prompt includes an option to register for the service and further wherein the mobile communications device comprises means for launching any one or more of:
a first registration screen prompt, the launching of the first registration screen prompt being triggered on: (i) the user operatively selecting the option to register on the first user screen prompt; and (ii) following authentication of the telephone number of the mobile telecommunications device from which communications are initiated, characterised in that the first registration screen prompt in use prompts the user to enter an identifier number, in the form of a passport number or any other identifier of the user;
a second registration screen prompt for prompting the user to enter the authentication pin number, the launching of the second registration screen prompt being triggered on the operative inputting of the user's identifier number by the user, characterised in that the second registration screen prompt further includes an option for the user to upload the card identifier numbers of one or more transaction cards of the user; and
a third registration screen prompt for notifying the user that the authentication pin number has been accepted and that the user has been registered, the launching of the third registration screen prompt being triggered on the operative authentication of the authentication pin number arising from the authentication pin number meeting certain pre-set parameters.

14-17. (canceled)

18. A method for conducting secure card transactions including the steps of:
(A) sending a communication initiation command by a user through the dialing a USSD string on a mobile telecommunications device;
(B) communicating the communication initiation command to a service provider through a USSD protocol via a telecommunication network to setup a USSD gateway between the user and the service provider;
(C) prompting the user for an authentication pin number and sending the authorisation pin number to the service provider;
(D) interrogating a service provider database with the authentication pin number for authenticating the user;
(E) prompting an authenticated user for:
(i) a command to switch at least one of a transaction card and account linked thereto between at least one of passive, active and stopped states thereby to prevent the processing of any transactions other than with at least one of the card and and/or card account in the active state; or
(ii) a command to update the state of at least one of an already active card and card account;
(F) switching at least one of the card and card account linked thereto to the state selected by the user, or updating the state of at least one of the already active card and card account; and
(G) automatically switching at least one of the card and card account to the passive state on attainment of a pre-set activation parameter.

19-20. (canceled)

21. A method according to claim 18, wherein the step of prompting the user for the command to switch or update the states of at least one of the card and card account is preceded by the step of prompting the user for a card identifier number selection from a list of card identifier numbers associated with the authentication pin number, such that the switching or updating command is applied to the card associated with the card identifier number selected by the user.

22. A method according to claim 21, wherein the method includes a step of prompting the user for the activation parameter following the user sending the update command.

23. A method according to claim 22, wherein the activation parameter is a number of allowable transactions or a length of time, such that on at least one of the number of allowable transactions being reached and the lapse of the selected length of time, at least one of the card and card account is automatically switched back to the passive state.

24. A method according to claim 23, wherein the method further includes the step of sending a notification to the user confirming that the relevant command has been process.

25. A method according to claim 24, wherein the notification is sent through at least one of the USSD gateway and through short message service (SMS).

26. A method according to claim 25, wherein the authentication pin number and one or more card identifier numbers are capable of being stored on the service provider database against a corresponding user telephone number such that the interrogating and authenticating step of the method is only concluded where the authentication pin number matches the telephone number of the mobile telecommunications device from which communication is initiated.

27. A method according to claim 26, wherein method commences with registration of the user through the steps of:
(A) sending a communication initiation command by a user through the dialing a USSD string on a mobile telecommunications device;
(B) communicating the communication initiation command to a service provider through a USSD protocol via a telecommunication network to setup a USSD gateway between the user and the service provider;
(C) prompting the user for a registration command;
(D) authenticating the user through one or more authentication procedures;
(E) prompting the user for an authentication pin number; and
(F) on receipt of the authentication pin number, notifying the user of successful registration.

28. A method according to claim 27, wherein the authentication procedures include at least one of authentication of a telephone number of the mobile communications device from which communication was initiated, and/or authentication of a user identifier number, being a passport number or some other identifier of the user.

29-30. (canceled)
